(19) United States
(12) Patent Application Publication
(10) Pub. No.: US 2021/0146644 A1
(43) Pub. Date: May 20, 2021

(54) Method for Manufacturing a Sole of an Article of Footwear

(71) Applicant: Mizuno Corporation, Osaka-shi (JP)

(72) Inventors: Kenjiro KITA, Osaka-shi (JP); Takao ODA, Osaka-shi (JP); Natsuki SATO, Osaka-shi (JP); Yo KAJIWARA, Osaka-shi (JP); Shingo SUDO, Osaka-shi (JP)

(21) Appl. No.: 17/097,125

(22) Filed: Nov. 13, 2020

(30) Foreign Application Priority Data
Nov. 18, 2019 (JP) 2019-208243

(51) Int. Cl. B29D 35/12; B29C 64/30; B29C 64/118; B33Y 10/00; B33Y 40/00; B33Y 50/00; B29C 64/386

(52) U.S. Cl. CPC B29D 35/122; B29C 64/30; B29C 64/118; B29K 2995/007; B33Y 40/00; B33Y 50/00; B29C 64/386; B33Y 10/00

(57) ABSTRACT

A method for manufacturing a sole of an article of footwear uses an additive manufacturing through a 3D printer. The sole body 20 has an inclined surface or a curved surface BL₀ to be a supported surface by a support at a toe spring portion Tu/a heel-up portion Hu/a side-up portion Su. The method includes a forming process in which a plurality of pillar-shaped supports 20sp that extend from the inclined/curved surface BL₀ toward the bottom surface of the sole at the time of forming the sole through the 3D printer, and a cutting process to cut at least a portion of the pillar-shaped supports 20sp.

### BACKGROUND OF THE INVENTION

The present invention relates generally to a method for manufacturing a sole of an article of footwear, and more particularly, to the method that can facilitate manufacturing of the sole with a supported surface by a support member or a support in an additive manufacturing of the sole through a 3D printer.

Recently, a 3D printer has been utilized in various fields that can form three-dimensional structures based on three-dimensional digital data. For example, Japanese patent application publication Nos. 2019-167498 (see paras. [0003] to [0004]), 2019-188744 (see paras. [0002] to [0005]), 2019-188815 (see paras. [0002] to [0005])) and 2017-94495 (see para. [0002]), and Japanese patent No. 6557145 (see paras. [0014] and [0138]).

In some cases, an inclined surface or curved surface such as a toe spring portion and the like, or a concave portion is provided/formed at a sole of a shoe. Also, a soft material is often used in order to maintain cushioning property that is required as a sole. In those cases, when a sole is formed through a fused deposition modeling, or one of an additive manufacturing by the 3D printer, there is need to add a support member or a support to the above-mentioned inclined surface/curved surface/concave portion in order to support such an inclined surface/curved surface/concave portion from below during forming (see Japanese patent application publication No. 2017-94495).

However, in the event that a support-member forming instruction is executed through a generally-used multipurpose program relative to a wedge-shaped space such as a toe spring portion of the sole and a concave space formed on the sole bottom surface, the support member is sometimes formed at a region unintended by a user. In that case, since the formed support member generally becomes a complicated three-dimensional structure such as a three-dimensional mesh structure, a three-dimensional slit structure and the like. It is practically difficult to remove such a support member in a post processing after forming.

The present invention has been made in view of these circumstances and its object is to provide an additive manufacturing method of a sole of an article of footwear through a 3D printer that can facilitate manufacture of the sole having a supported surface by a support such as an inclined surface/curved surface/concave portion.

Other objects and advantages of the present invention will be obvious and appear hereinafter.

### SUMMARY OF THE INVENTION

A method for manufacturing a sole of an article of footwear according to the present invention is an additive manufacturing using a 3D printer. The sole includes a supported surface by a support at the time of forming the sole by the 3D printer. The method comprising:

i) A forming process in which a plurality of pillar-shaped supports that extend from the supported surface toward a bottom surface of the sole are formed at the time of forming the sole by the 3D printer; and

ii) A cutting process to cut at least a part of the pillar-shaped supports.

According to the present invention, since a support member formed at the supported surface at the time of forming the sole by the 3D printer is formed of a plurality of pillar-shaped supports extending toward the sole bottom surface, cutting of the supports after forming becomes easy, thereby facilitating manufacture of the sole with such a supported surface as an inclined surface/curved surface/concave portion.

The supported surface may be an inclined surface or a curved surface that is provided at a toe spring portion of a sole tiptoe part, a heel-up portion at a heel rear end, or a side-up portion at a lower end edge part on medial and lateral sides. Thereby, it becomes possible to form a sole with the inclined surface/curved surface by the 3D printer.

The supported surface may be a concaved ceiling surface formed at the bottom surface of the sole. Thereby, it becomes possible to form the sole with the concave portion by the 3D printer.

The pillar-shaped supports maybe arranged in alignment at a predetermined interval at the supported surface.

In the cutting process, the pillar-shaped supports formed at the supported surface may be cut with a proximal portion of the pillar-shaped supports remained or left behind so that the pillar-shaped supports can constitute a ground-contact surface design at the bottom surface of the sole.

In this case, there is no need to cut the pillar-shaped supports at the base thereof and the proximal portion of the pillar-shaped supports can be utilized as the ground-contact surface design of the bottom surface of the sole, thus further facilitating manufacture of the sole.

At a remaining region of the bottom surface of the sole, there may be formed a plurality of convex portions or projections similar to the proximal portions of the pillar-shaped supports and the convex portions may constitute a ground-contact surface design at a bottom surface of the sole along with the proximal portions of the pillar-shaped supports.

In this case, a plurality of projection designs on the entire sole bottom surface are formed, thus improving gripping performance, skid-proof capacity and drainability as the ground contact surface all over the sole bottom surface.

In the cutting process, the pillar-shaped supports may be removed from the supported surface of the sole.

In the forming process, a plurality of protrusions may be formed that extend in a direction intersecting a circumferential direction on an outer circumferential surface of the sole and bottom portions of these protrusions may constitute a ground-contact surface design at the bottom surface of the sole along with the pillar-shaped supports.

In this case, since the bottom portions of the protrusions constitute the ground-contact surface design, gripping performance and skid-proof capacity of the ground surface can be further improved, and an area of the whole ground contact surface can be enlarged, thus enhancing a landing stability.

The additive manufacturing by the 3D printer may be a fused deposition modeling.

Forming of the sole and the pillar-shaped supports through the additive manufacturing by the 3D printer may be performed using a soft material having an Asker A hardness of 90 A or less.

As above-mentioned, according to the present invention, since a support member formed at the supported surface at the time of forming the sole through the additive manufacturing by the 3D printer is formed of a plurality of pillar-shaped supports extending toward the sole bottom surface, it become easy to cut the supports after forming, thus facilitating manufacture of the sole with such a supported surface as an inclined surface/curved surface or a concave portion.

### BRIEF DESCRIPTION OF THE DRAWINGS

For a more complete understanding of the invention, reference should be made to the embodiments illustrated in greater detail in the accompanying drawings and described below by way of examples of the invention.

FIG. 1 is a flow chart illustrating an example of a sole forming process in a sole manufacturing method according to an embodiment of the present invention.

FIG. 2 is a general top perspective medial-side view of the sole (for a right foot) formed in the sole forming process of FIG. 1, viewed from diagonally forward.

FIG. 3 is a general top perspective medial-side view of the sole of FIG. 2, viewed from diagonally behind.

FIG. 4 is a general bottom perspective medial-side view of the sole of FIG. 2.

FIG. 5 is a medial side view of the sole of FIG. 2.

FIG. 6 is a lateral side view of the sole of FIG. 2.

FIG. 7 is an enlarged view of a portion of the sole of FIG. 2, illustrating a tiptoe portion of the sole.

FIG. 8 shows a cutting region of the pillar-shaped supports in FIG. 7.

FIG. 9 shows the state in which the pillar-shaped supports in FIG. 8 have been cut.

FIG. 10 is an enlarged view of a portion of the sole of FIG. 2, illustrating a rear end portion of the sole.

FIG. 11 shows a cutting region of the pillar-shaped supports in FIG. 10.

FIG. 12 shows the state in which the pillar-shaped supports in FIG. 11 have been cut.

FIG. 13 is a heel rear end view of the sole of FIG. 2, illustrating a cutting region of the pillar-shaped supports.

FIG. 14 shows the state in which the pillar-shaped supports in FIG. 13 have been cut.

FIG. 15 is a frontend view of the forefoot region of the sole of FIG. 2, illustrating a cutting region of the pillar-shaped supports.

FIG. 16 shows the state in which the pillar-shaped supports in FIG. 15 have been cut.

FIG. 17 is a general top perspective lateral-side view of the sole (for a right foot) manufactured by the sole manufacturing method according to an embodiment of the present invention, viewed from diagonally behind and illustrated along with an upper.

FIG. 18 is a medial side view of the sole of FIG. 17.

FIG. 19 is a heel rear end view of the sole of FIG. 17.

FIG. 20 is a top plan view of the sole of FIG. 17.

FIG. 21 is a bottom view of the sole of FIG. 17.

FIG. 22 is a general perspective medial-side view of a variant of the sole of FIG. 2, viewed from diagonally forward.

FIG. 23 is a general bottom perspective medial-side view of the sole of FIG. 22, viewed from below.

FIG. 24A is a lateral side view of the sole according to a variant of the sole forming process.

FIG. 24B is a general top perspective lateral-side view of the sole of FIG. 24A.

FIG. 24C is a general bottom perspective lateral-side view of the sole of FIG. 24A.

FIG. 25 is a general bottom perspective view of another variant of the sole of FIG. 2.

FIG. 26 shows the state in which the pillar-shaped supports in FIG. 25 have been cut.

FIG. 27A is a cross sectional view of FIG. 25 taken along line XXVII-XXVII.

FIG. 27B shows a variant of FIG. 27A.

FIG. 27C shows another variant of FIG. 27A.

FIG. 28 is a cross sectional view of the sole, illustrating a variant of FIG. 13.

### DETAILED DESCRIPTION OF THE PREFERRED EMBODIMENTS

The present invention will now be described in detail with reference to embodiments thereof as illustrated in the accompanying drawings.

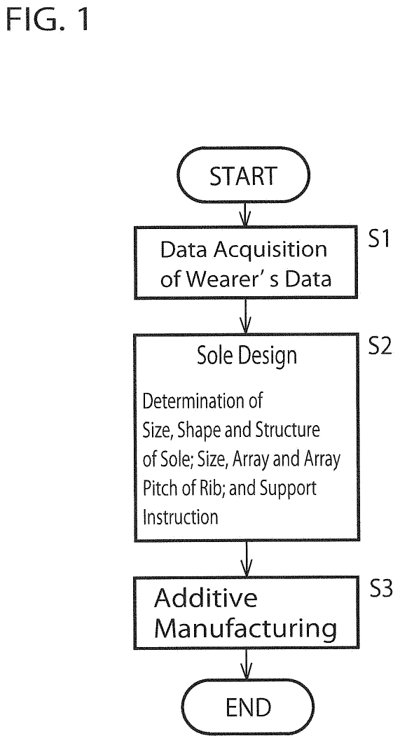

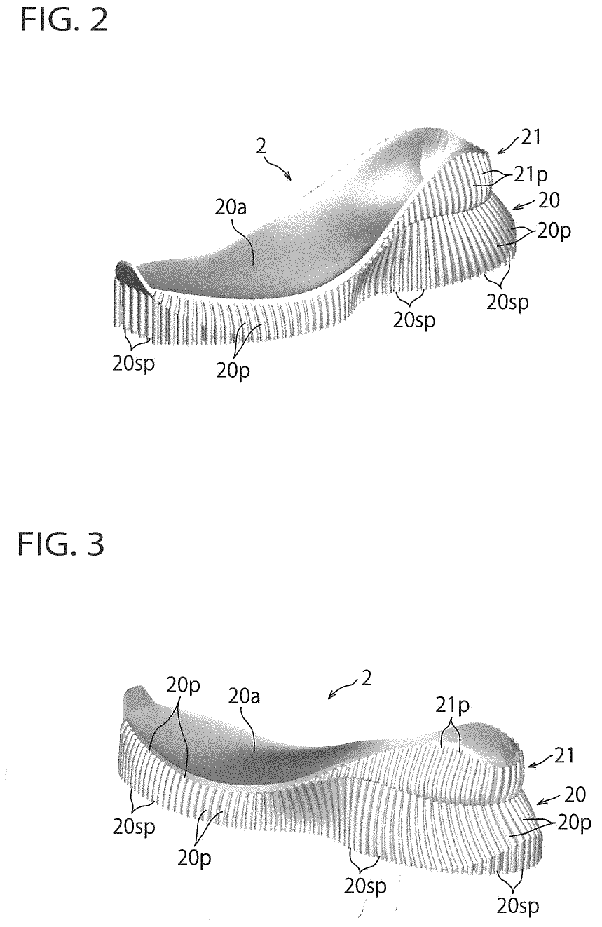

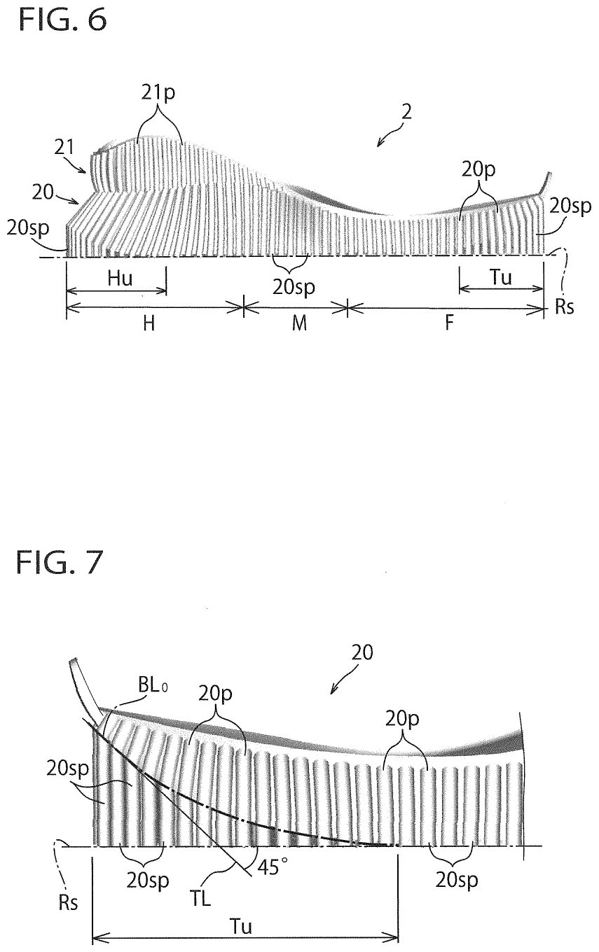

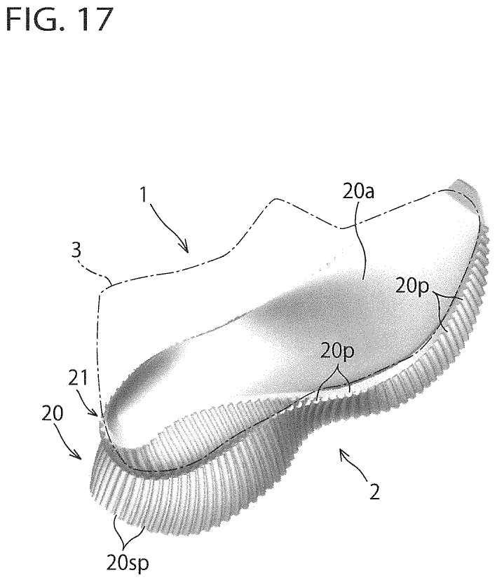

Referring to the drawings, FIGS. 1 to 21 show a manufacturing method of a sole of an article of footwear according to an embodiment of the present invention. FIG. 1 is a flow chart explaining an example of a sole forming process by an additive manufacturing through a 3D printer in the sole manufacturing method; FIGS. 2 to 8, 10, 11, 13 and 15 show a sole formed by the 3D printer; FIGS. 9, 12, 14 and 16 illustrate a state in which pillar-shaped supports have been cut from the formed sole; and FIGS. 17 to 21 shows the sole after the pillar-shaped supports were cut. Here, a running shoe is taken for an example as an article of footwear.

First, a sole forming process through the additive manufacturing by the 3D printer will be explained using the flowchart shown in FIG. 1.

The flowchart of FIG. 1 is processed in accordance with a program that was pre-installed into a memory (not shown) of for example, a personal computer.

When the program starts, at step S1 of FIG.

1, a shoe wearer's data is acquired that includes foot data of the wearer. Such foot data may include three-dimensional foot data (e.g. foot length, foot width, arch height, foot sole shape, etc.), and may further include foot pressure distribution and the like. The wearer's data may include personal data such as a wearer's weight and running style (e.g. a heel-striker-type, midfoot-striker-type, or a forefoot-striker-type).

Then, at step S2, a sole is designed based on the wearer's data acquired at step S1. In this process, a size, shape and structure (e.g. solid/hollow, etc.) of the sole; and a size (e.g. 3 mm in diameter), array and array pitch of a rib (or protrusion) formed around an outer circumferential surface of the sole are determined.

Moreover, a support instruction is performed. That is, an area is indicated where support by a support member or a support is needed at the time of forming the sole. At this juncture, as a support, a plurality of pillar-shaped supports spaced apart from each other at a predetermined pitch are employed. In this exemplification, as an area where support by a support member or a support is needed, an area is instructed that has an inclined surface (i.e. a supported surface by the support) forming 45 degrees or less relative to a reference plane at the time of forming the sole, i.e. a base surface on which a formed sole is to be placed,

Then, at step S3, the sole that has been designed at step S2 is formed/3D-printed together with the ribs and the pillar-shaped supports by the additive manufacturing, preferably through the 3D printer. As the 3D printer, FDM (Fused Deposition Modeling) -method type is preferably used. This method utilizes thermoplastic resin such as nylon, polyester, TPU (thermo plastic polyurethane), PU (polyurethane), thermoplastic elastomer and the like, or rubber and the like. A soft material is preferable and a soft material having the Asker A hardness of 90 A or below is more preferable. Also, at the time of forming the sole by the 3D printer, a horizonal posture in which the bottom surface of the sole is disposed on the reference plane may be employed.

FIGS. 2 to 8, 10, 11, 13 to 15 show a sole 2 that was formed through the additive manufacturing by the 3D printer. In the illustrated example, a sole for a right foot is taken as an example. In the following explanation, “upward (upper side/upper)” and “downward (lower side/lower)” designate an upward direction and a downward direction, respectively, or vertical direction of the sole, “forward (front side/front)” and“rearward (rear side/rear)” designate a forward direction and a rearward direction, respectively, or longitudinal direction of the sole, and “a width or lateral direction” designates a crosswise direction of the sole. For example, in the case where a bottom of the shoe is placed on a horizontal plane as shown in FIG. 5, “upward” and “downward” generally designate “upward” and “downward” in FIG.5, respectively, “forward” and “rearward” generally designate “left to right direction” in FIG. 5, respectively, and “a width direction” generally designates “out of the page” and “into the page” of FIG. 5, respectively.

As shown in FIGS. 2 to 6 (especially, in FIG. 5), Sole 2 includes a sole body 20 that comprises a heel region H, a midfoot region M and a forefoot region F that correspond to a heel portion, a midfoot portion (or plantar arch portion) and a forefoot portion of the foot of the wearer, respectively. The sole body 20 has a foot sole contact surface 20a on a top surface thereof that comes into direct contact with or indirect contact via an insole (not shown), etc. with a foot sole of the wearer. The foot sole contact surface 20a preferably forms a curved surface that gently curves along the longitudinal direction so as to follow the contour of the shape of the foot sole of the wearer.

There is provided a heel counter portion 21 mainly at the heel region H of the sole body 20, which is disposed above the sole body 20 and extends along the perimeter of the heel region H. The heel counter portion 21 extends upwardly from the foot sole contact surface 20a of the sole body 20 so as to surround and support the circumference of the heel portion of the foot of the wearer.

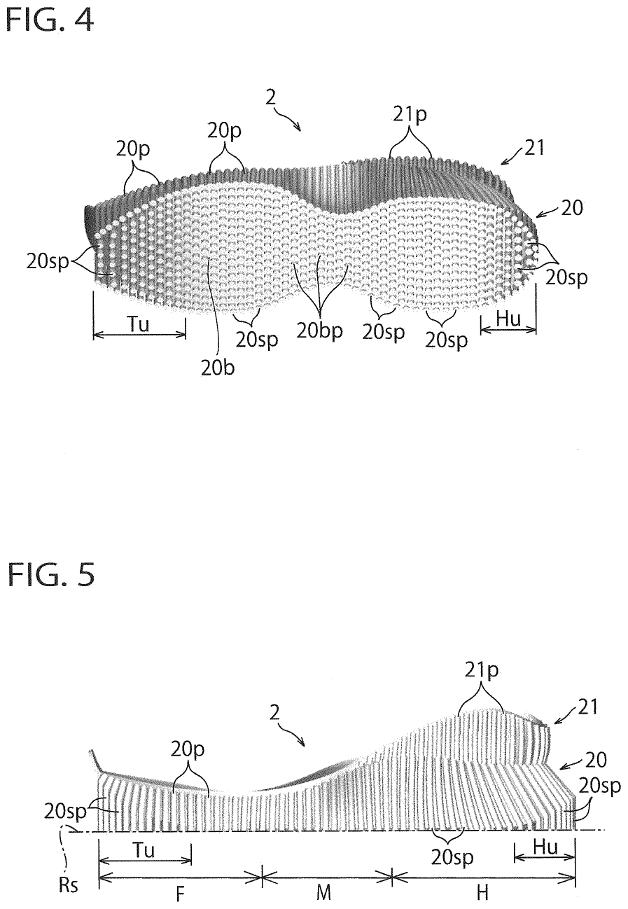

On the bottom surface 20b (FIG. 4) of the sole body 20, a number of pillar-shaped protrusions 20bp are provided, which are integral with the bottom surface 20b. In this exemplification, as a pillar-shaped protrusion 20bp, a solid cylindrical protrusion of a circular cross-sectional shape may be used. Also, the protruding amount of the pillar-shaped protrusions 20bp from the bottom surface 20b of the sole body 20 is set to, for example, a few tenths of a millimeter to a few millimeters. The pillar-shaped protrusions 20bp are arranged in alignment at a predetermined interval at the bottom surface 20b. A bottom surface of the pillar-shaped protrusions 20bp forms a ground contact surface that comes into contact with the ground.

On an outer circumference of the sole body 20, a plurality of ribs (or protrusions) 20p are provided that extend in a pillar-shape in a direction intersecting a circumferential direction, i.e. in a substantially vertical direction. In this exemplification, the ribs 20p are provided from the heel region H through the midfoot region M to the forefoot region F on both the medial side and the lateral side of the sole body 20, disposed along the perimeter of the heel rear end of the heel region H and the perimeter of the tiptoe part of the forefoot region F. That is, the ribs 520p are provided around the entire perimeters of the heel region H, the midfoot region M and the forefoot region F.

Also, in the illustrated embodiment, as the rib 20p, a solid cylindrical (or semi-cylindrical) protrusion of a circular (or simi-circular) cross-sectional shape may be used. The ribs 20p extend downwardly beyond the bottom surface 20b of the sole body 20 and lower surfaces of the ribs 20p are generally flush with lower surfaces of the pillar-shaped protrusions 20bp. Thereby, the lower surfaces of the ribs 20p constitute the ground contact surface along with the lower surfaces of the pillar-shaped supports 20bp. That is, the lower surfaces of the ribs 20p and the lower surfaces of the pillar-shaped supports 20bp constitute a ground contact design of the bottom surface 20b of the sole body 20. Also, similarly, on an outer circumferential surface of the heel counter portion 20, a number of ribs (or protrusions) 21p are formed that extend substantially in the vertical direction.

There is provided a toe spring portion Tu (FIGS. 4 to 9) at a tiptoe portion of the sole body 20 as a finished product. Therefore, as shown in FIG. 7, the sole body 20 has an inclined surface/curved surface (or a supported surface) BL₀ at the tiptoe portion, which inclines/curves relative to the reference plane Rs at the time of forming by the 3D printer.

Inclination of the tangential line TL of the inclined surface/curved surface BL₀ relative to the reference plane Rs may be 45 degrees or less along the inclined surface/curved surface BL₀. That is, the maximum inclination is 45 degrees (see FIG. 7). Because if the inclination is over 45 degrees there is a high possibility that defective forming will occur. Therefore, a wedge-shaped space formed between the inclined/curved surface BL₀ and the reference plane Rs is selected as a space in need of supporting by a support member/a support at the time of forming by the 3D printer. As a result, as shown in FIG. 7, after forming by the 3D printer, a plurality of pillar-shaped supports 20sp extending from the inclined/curved surface BL₀ toward the reference plane Rs are formed at the inclined/curved surface BL₀ and integrated with the sole body 20 in the wedge-shaped space. In the illustrated embodiment, the pillar-shaped supports 20sp extend in a direction perpendicular to the reference plane Rs.

As for the pillar-shaped protrusions 20bp, a solid cylindrical protrusion of a circular cross-sectional shape may be used. The pillar-shaped supports 20sp disposed along the outer circumferential edge portion of the toe spring portion Tu are arranged in alignment vertically with the ribs 20p formed at the outer circumferential surface of the sole body 20 (see FIG. 7). The pillar-shaped supports 20sp are aligned with each other at a predetermined interval at the toe spring portion Tu (see FIG. 4). For example, in the case that a diameter of the pillar-shaped support 20sp is 3 mm, an interval between the adjacent pillar-shaped supports 20sp may be set to 2 mm. When a soft material is used at the time of forming by the 3D printer, the interval between the adjacent pillar-shaped supports 20sp at the toe spring portion Tu is preferably set to 2 mm or less.

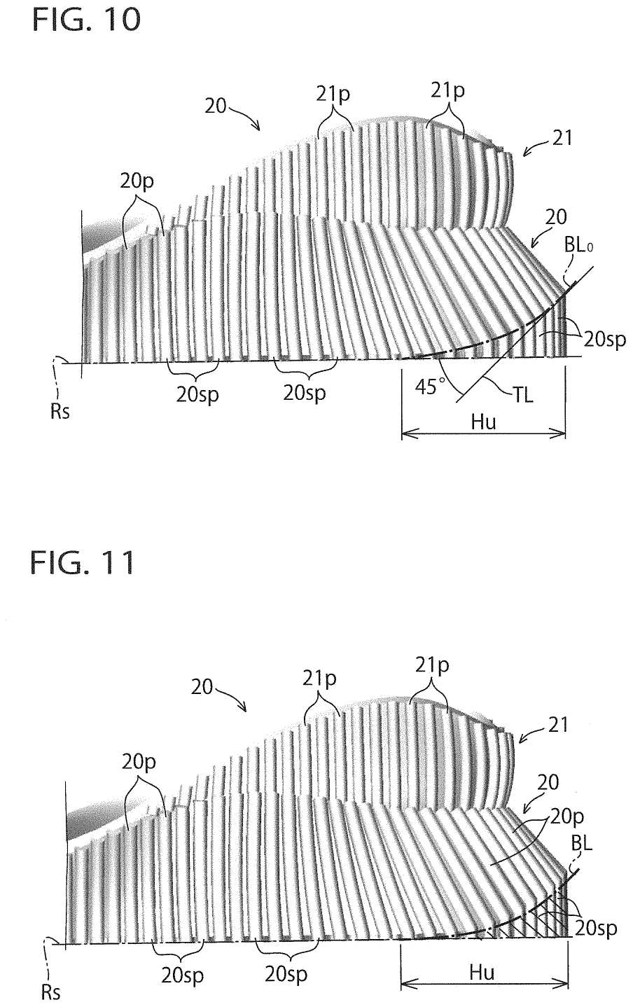

There is provided a heel-up portion Hu (FIGS. 4 to 6, 10 to 12) at a heel rear end portion of the sole body 20 as a finished product. Therefore, as shown in FIG. 10, the sole body 20 has an inclined surface/curved surface (or a supported surface) BL₀ at the heel rear end portion, which inclines/curves relative to the reference plane Rs at the time of forming by the 3D printer.

Inclination of the tangential line TL of the inclined surface/curved surface BL₀ relative to the reference plane Rs may be 45 degrees or less along the inclined surface/curved surface BL₀, similar to the toe spring portion Tu. That is, the maximum inclination is 45 degrees (see FIG. 10). Because if the inclination is over 45 degrees there is a high possibility that defective forming will occur. Therefore, a wedge-shaped space formed between the inclined/curved surface BL₀ and the reference plane Rs is selected as a space in need of supporting by a support member/a support at the time of forming by the 3D printer. As a result, as shown in FIG. 10, after forming by the 3D printer, a plurality of pillar-shaped supports 20sp extending from the inclined/curved surface BL₀ toward the reference plane Rs are formed at the inclined/curved surface BL₀ and integrated with the sole body 20 in the wedge-shaped space. In the illustrated embodiment, the pillar-shaped supports 20sp extend in a direction perpendicular to the reference plane Rs.

As for the pillar-shaped protrusions 20bp, a solid cylindrical protrusion of a circular cross-sectional shape may be used. The pillar-shaped supports 20sp disposed along the outer circumferential edge portion of the heel-up portion Hu are arranged in alignment vertically with the ribs 20p formed at the outer circumferential surface of the sole body 20 (see FIG. 10). The pillar-shaped supports 20sp are aligned with each other at a predetermined interval at the heel-up portion Hu (see FIG. 4). For example, in the case that a diameter of the pillar-shaped support 20sp is 3 mm, an interval between the adjacent pillar-shaped supports 20sp may be set to 2mm. When a soft material is used at the time of forming by the 3D printer, the interval between the adjacent pillar-shaped supports 20sp at the heel-up portion Hu is preferably set to 2 mm or less.

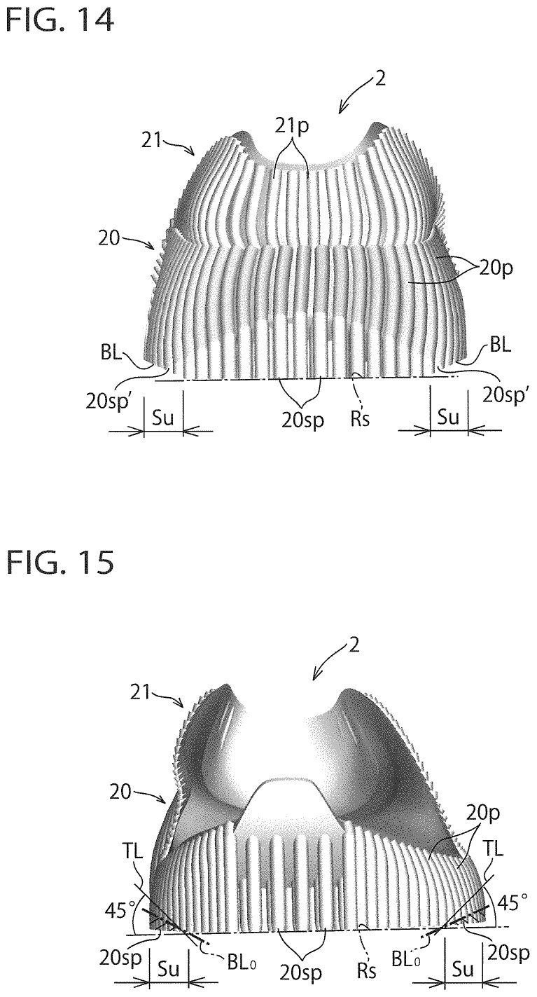

There is provided a side-up portion Su (FIGS. 13 to 16) at lower end edge portions of the medial and lateral sides of the sole body 20 as a finished product. Therefore, as shown in FIGS. 13 and 15, the sole body 20 has an inclined surface/curved surface (or a supported surface) BL₀ at the lower end edge portions of the medial and lateral sides, which inclines/curves relative to the reference plane Rs at the time of forming by the 3D printer.

Inclination of the tangential line TL of the inclined surface/curved surface BL₀ relative to the reference plane Rs may be 45 degrees or less along the inclined surface/curved surface BL₀, similar to the toe spring portion Tu. That is, the maximum inclination is 45 degrees (see FIG. 13). Because if the inclination is over 45 degrees there is a high possibility that defective forming will occur. Therefore, a wedge-shaped space formed between the inclined/curved surface BL₀ and the reference plane Rs is selected as a space in need of supporting by a support member/a support at the time of forming by the 3D printer. As a result, as shown in FIGS. 13 and 15, after forming by the 3D printer, a plurality of pillar-shaped supports 20sp extending from the inclined/curved surface BL₀ toward the reference plane Rs are formed at the inclined/curved surface BL₀ and integrated with the sole body 20 in the wedge-shaped space. In the illustrated embodiment, the pillar-shaped supports 20sp extend in a direction perpendicular to the reference plane Rs.

As for the pillar-shaped protrusions 20bp, a solid cylindrical protrusion of a circular cross-sectional shape may be used. The pillar-shaped supports 20sp disposed along the outer circumferential edge portion of the side-up portion Su are arranged in alignment vertically with the ribs 20p formed at the outer circumferential surface of the sole body 20 (see FIGS. 13 and 15). The pillar-shaped supports 20sp are aligned with each other at a predetermined interval at the side-up portion Su (see FIG. 4). For example, in the case that a diameter of the pillar-shaped support 20sp is 3 mm, an interval between the adjacent pillar-shaped supports 20sp may be set to 2 mm. When a soft material is used at the time of forming by the 3D printer, the interval between the adjacent pillar-shaped supports 20sp at the heel-up portion Hu is preferably set to 2 mm or less.

Now, the manufacturing process after forming by the 3D printer will be explained hereinafter.

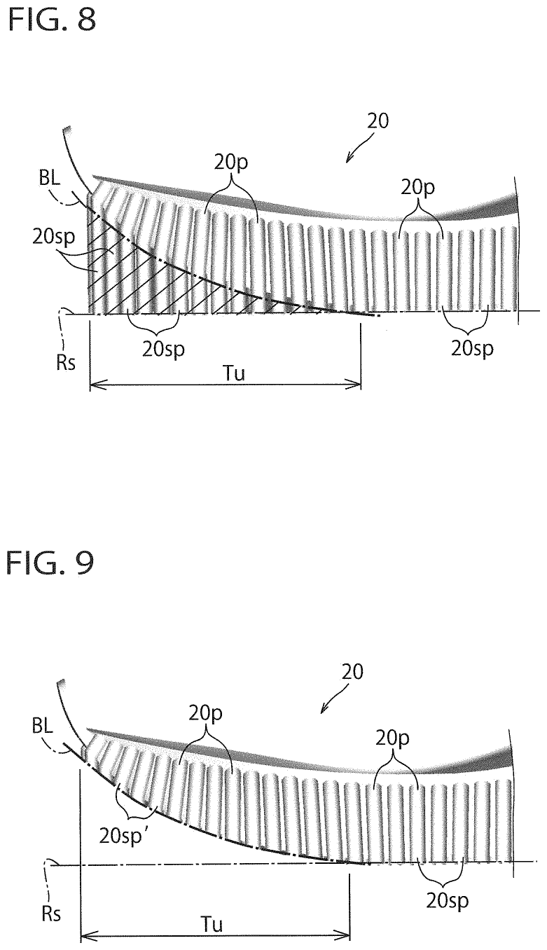

As for the toe spring portion Tu of the sole body 20, as shown in FIG. 8, a cutting plane BL is set disposed below and parallel to the inclined/curved surface BL₀ (FIG. 7) and spaced a few tenths of a millimeter to a few millimeters apart from the inclined/curved surface BL₀. Then, the pillar-shaped supports 20sp are cut along the cutting plane BL. In FIG. 8, a cutting area is shown by hatching. Thereby, as shown in FIG. 9, at the toe spring portion Tu, proximal portions 20sp′ of the pillar-shaped supports 20sp are left behind and thus lower surfaces of the proximal portions 20sp′ of the pillar-shaped supports 20sp form the ground contact surface. That is, the lower surfaces of the proximal portions 20sp′ of the pillar-shaped supports 20sp constitute a ground-contact surface design of the toe spring portion Tu. The proximal portions 20sp′ of the pillar-shaped supports 20sp are solid cylindrical protrusions as with the pillar-shaped protrusions 20bp and the ribs 20p.

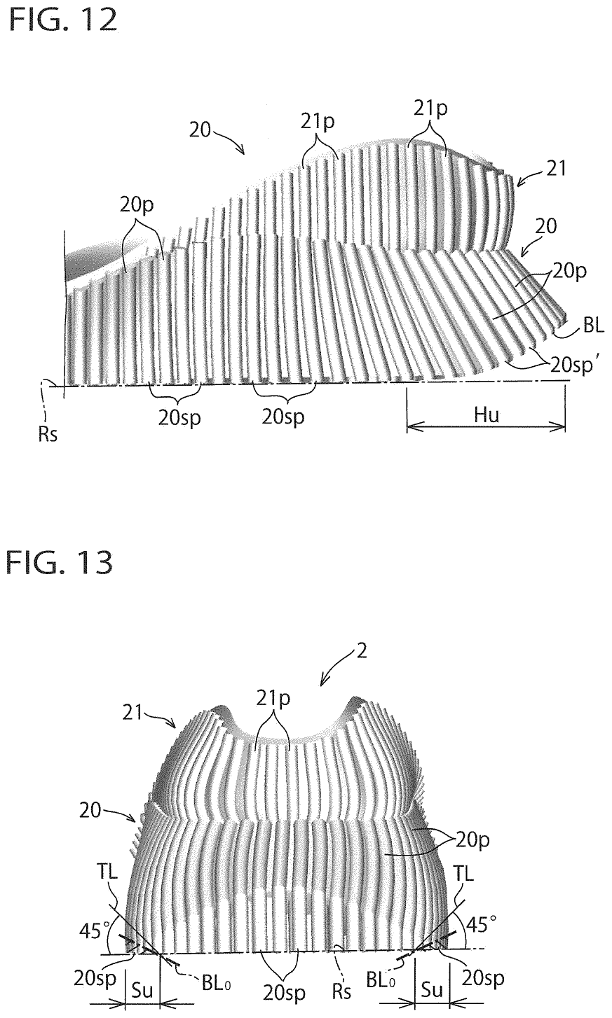

As for the heel-up portion Hu of the sole body 20, as shown in FIG. 11, a cutting plane BL is set disposed below and parallel to the inclined/curved surface BL₀ (FIG. 10) and spaced a few tenths of a millimeter to a few millimeters apart from the inclined/curved surface BL₀. Then, the pillar-shaped supports 20sp are cut along the cutting plane BL. In FIG. 11, a cutting area is shown by hatching. Thereby, as shown in FIG. 12, at the heel-up portion Hu, proximal portions 20sp′ of the pillar-shaped supports 20sp are left behind and thus lower surfaces of the proximal portions 20sp′ of the pillar-shaped supports 20sp form the ground contact surface. That is, the lower surfaces of the proximal portions 20sp′ of the pillar-shaped supports 20sp constitute a ground contact surface design of the heel-up portion Hu. The proximal portions 20sp′ of the pillar-shaped supports 20sp are solid cylindrical protrusions as with the pillar-shaped protrusions 20bp and the ribs 20p.

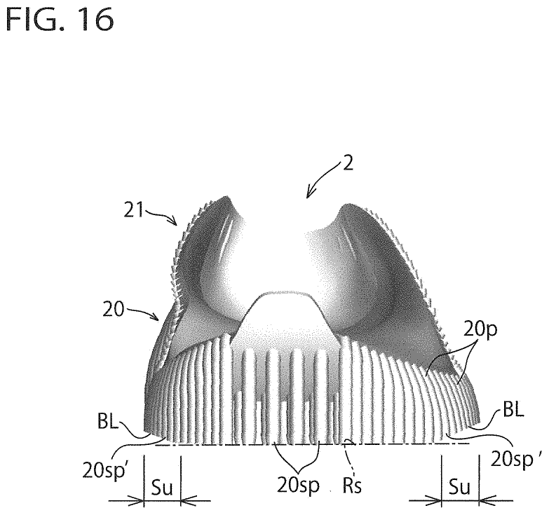

As for the side-up portion Su of the sole body 20, as shown in FIGS. 14 and 16, a cutting plane BL is set disposed below and parallel to the inclined/curved surface BL₀ (FIGS. 13 and 15) and spaced a few tenths of a millimeter to a few millimeters apart from the inclined/curved surface BL₀. Then, the pillar-shaped supports 20sp are cut along the cutting plane BL. In FIGS. 13 and 15, a cutting area is shown by hatching. Thereby, as shown in FIGS. 14 and 16, at the side-up portion Su, proximal portions 20sp′ of the pillar-shaped supports 20sp are left behind and thus lower surfaces of the proximal portions 20sp′ of the pillar-shaped supports 20sp form the ground contact surface. That is, the lower surfaces of the proximal portions 20sp′ of the pillar-shaped supports 20sp constitute a ground contact surface design of the side-up portion Su. The proximal portions 20sp′ of the pillar-shaped supports 20sp are solid cylindrical protrusions as with the pillar-shaped protrusions 20bp and the ribs 20p.

FIGS. 17 to 21 show a sole that has been manufactured by the above-mentioned manufacturing method.

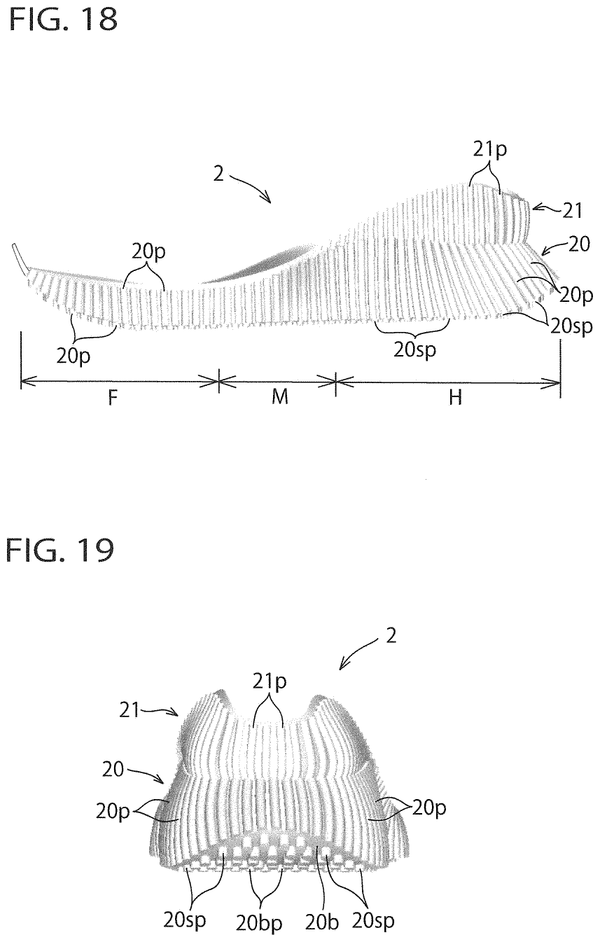

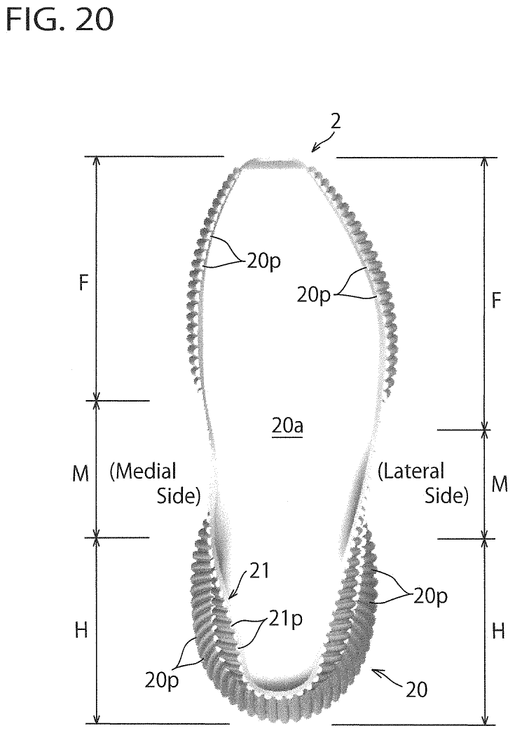

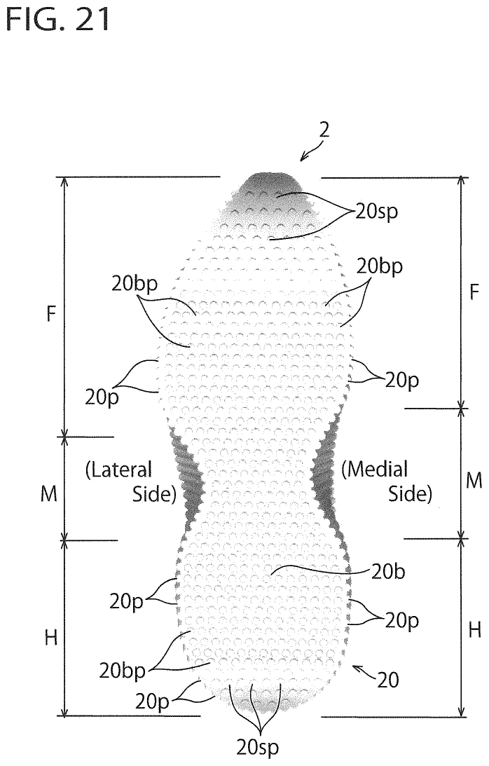

As shown in FIG. 17, a general perspective view, a lower portion of an upper 3 shown by a dash-and-dot line is fixedly attached to the foot sole contact surface 20a and the heel counter portion 21 of the sole body 20 through boding or the like, thus making a shoe 1 completed. As shown in FIG. 18 (or a medial side view), FIG. 19 (or a heel rear end view), FIG. 20 (a top plan view), and FIG. 21 (a bottom view), at the bottom surface 20b of the sole body 20, the proximal portions 20sp′ of the pillar-shaped supports 20sp, the pillar-shaped protrusions 20bp and the ribs 20p are provided, which are aligned with each other and spaced a predetermined interval as solid cylindrical protrusions and which respectively constitute a ground contact design.

According to the present embodiment, at the time of forming the sole through the additive manufacturing by the 3D printer, since a support member/a support formed at the inclined surface/curved surface (i.e. toe spring portion Tu/heel-up portion Hu/side-up portion Su) of the bottom surface 20b of the sole body 20 is composed of a plurality of pillar-shaped supports 20sp, cutting of the pillar-shaped supports after forming becomes easy not only at the inclined/curved surface of the sole body 20 but also on the side of the sole bottom surface 20b, thus facilitating manufacture of the sole with an inclined/curved surface.

According to the current embodiment, at the time of forming the sole by the 3D printer, since the sole is designed based on a wearer's data including actual foot date and personal data of the wearer, personal fit soles can be achieved that are customized according to individual feet of wearers. Also, since the sole is integrally formed (or simultaneously printed) by the 3D printer, a manufacturing cost can be reduced.

According to the present embodiment, when cutting the pillar-shaped supports 20sp after forming the sole by the 3D printer, the pillar-shaped supports 20sp are cut along the inclined/curved surface with the proximal portions 20sp′ of the pillar-shaped supports 20sp formed at the inclined/curved surface left behind, such that thereby the proximal portions 20sp′ of the pillar-shaped supports 20sp can be utilized as a ground-contact surface design of the inclined/curved surface of the sole body 20, thus further facilitating manufacture of the sole. Also, since the entire sole bottom surface 20b including the inclined/curved surface of the sole body 20 is formed with a number of substantially identically shaped protrusions, not only a design of the entire sole bottom surface 20b can be unified and design effect can be exhibited but also gripping performance, skid-proof capacity and drainability as the ground contact surface can be improved at the whole sole bottom surface 20b by the protrusions.

According to the present invention, at the time of forming the sole by the 3D printer, since a plurality of ribs 20p are formed that extend in a direction intersecting a circumferential direction at an outer circumferential surface of the sole body 20, not only rigidity of the outer circumferential surface of the sole body 20 can be increased and durability of the sole body 20 can be improved but also the amount of elastic deformation of the outer circumferential surface of the sole body 20 can be adjusted, thus controlling cushioning property and stability of the sole body 20. Moreover, since the lower portions of the ribs 20p constitute a ground-contact surface design of the sole bottom surface 20b along with the pillar-shaped protrusions 20bp of the sole bottom surface 20b and the proximal portions 20sp′ of the of the pillar-shaped supports 20sp, anti-slip capacity and gripping performance of the ground contact surface can be further improved and an area of the whole ground contact surface can be enlarged, thus improving landing stability. Furthermore, according to the present invention, a plurality of ribs 21p are formed at an outer circumferential surface of the heel counter portion 21 on the upper side of the sole body 20, thereby increasing the rigidity of the heel counter portion 21 and enhancing holdability of the heel portion of the wearer's foot during exercise.

In the current embodiment, since a soft material of Asker A scale hardness of 90 A or less is used at the time of forming the sole by the 3D printer, cutting/removal after forming becomes hard and defective forming is likely to occur at the inclined/curved surface. However, according to the present embodiment, by forming a plurality of pillar-shaped supports 20sp at the inclined/curved surface, forming of the inclined/curved surface is performed supporting the inclined/curved surface from below by the pillar-shaped supports 20sp. As a result of this, a defective forming or a forming failure at the inclined/curved surface can be prevented.

### First Alternative Embodiment

In the above-mentioned embodiment, an example was shown in which the inclined/curved surface BL₀ formed at a portion of the bottom surface 20b of the sole body 20 is provided at every portion of the toe spring portion Tu of the tiptoe, the heel-up portion Hu at the heel rear end and the side-up portion Su at the lower end edge portion of the medial and lateral sides of the sole body 20. However, the inclined/curved surface BL₀ may not be provided at all of the portions Tu, Hu and Su. According to a shoe that the present invention is applied to, the inclined/curved surface BL₀ may be provided at either one or two of the portions Tu, Hu and Su.

### Second Alternative Embodiment

In the above-mentioned embodiment, an example was shown in which as a region in need of support by a support member/a support, a region of the inclined/curved surface BL₀ is designated in which an angle of the inclined/curved surface BL₀ relative to the reference plane Rs at the time of forming by the 3D printer is 45 degrees or less, but the application of the present invention is not restricted to such an example. According to a material to be used, and forming conditions and the like, an angle more or less than 45 degrees may be adopted.

### Third Alternative Embodiment

In the above-mentioned embodiment, an example was shown in which when cutting the pillar-shaped supports 20sp at the toe spring portion Tu/the heel-up portion Hu/the side-up portion Su of the sole body 20, the pillar-shaped supports 20sp were cut with the proximal portion 20sp′ of the pillar-shaped supports 20sp left behind, but the application of the present invention is not limited to such an embodiment. When cutting the pillar-shaped supports 20sp, the entire length of the pillar-shaped supports 20sp may be cut to be removed from the toe spring portion Tu/the heel-up portion Hu/the side-up portion Su of the sole body 20 without leaving the proximal portion 20sp′ behind.

### Fourth Alternative Embodiment

In the above-mentioned embodiment, an example was shown in which as the pillar-shaped supports 20sp provided at the inclined/curved surface of the sole body 20, a solid cylindrical protrusion of a circular cross-sectional shape is used. However, a cross-sectional shape of the pillar-shaped supports 20sp is not restricted to a circle. An elliptical or oval cross-sectional shape, alternatively, a polygonal cross-sectional shape such as hexagonal, octagonal or the like may be used. The same holds true for the pillar-shaped protrusions 20bp at the bottom surface 20b of the sole body 20. Also, as for the ribs 20p provided at the outer circumferential surface of the sole body 20, a solid cylindrical or semi-cylindrical protrusion of a circular or semi-circular cross-sectional shape is used. However, a cross-sectional shape of the ribs 20p is not restricted to a circle or a semi-circle. Similarly, an elliptical or oval cross-sectional shape, alternatively, a polygonal cross-sectional shape such as hexagonal, octagonal or the like may be used.

### Fifth Alternative Embodiment

In the above-mentioned embodiment, an example was shown in which the ribs 20p are arranged at a generally constant array pitch in the longitudinal direction, but the application of the present invention is not restricted to such an example. The array pitch may not be constant, but variation in pitch length may be given to the array pitch. For example, the ribs 20p maybe densely disposed by shortening the array pitch in the heel region H or the midfoot region M, whereas the ribs 20p maybe sparsely disposed by lengthening the array pitch in other regions.

### Sixth Alternative Embodiment

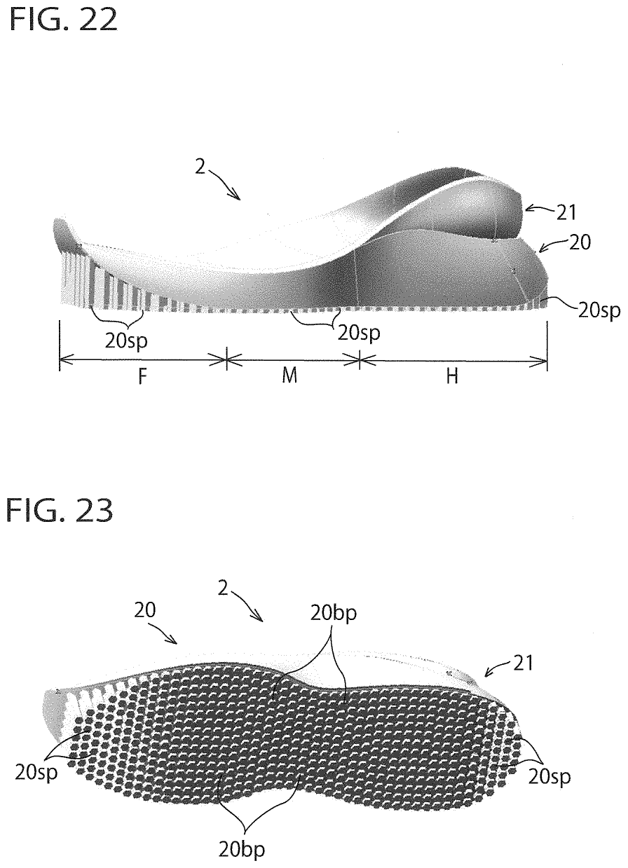

In the above-mentioned embodiment, an example was shown in which a plurality of ribs 20p are formed at the outer circumferential surface of the sole body 20, but these ribs may be omitted as shown in FIGS. 22 and 23. In these drawings, an example is shown in which ribs are also omitted at the outer circumferential surface of the heel counter portion 21 disposed on the upper side of the sole body 20. In these drawings, an example is shown in which the pillar-shaped supports 20sp and the pillar-shaped protrusions 20bp are formed of hexagonal pillar-shaped protrusions of hexagonal cross-sectional shape.

### Seventh Alternative Embodiment

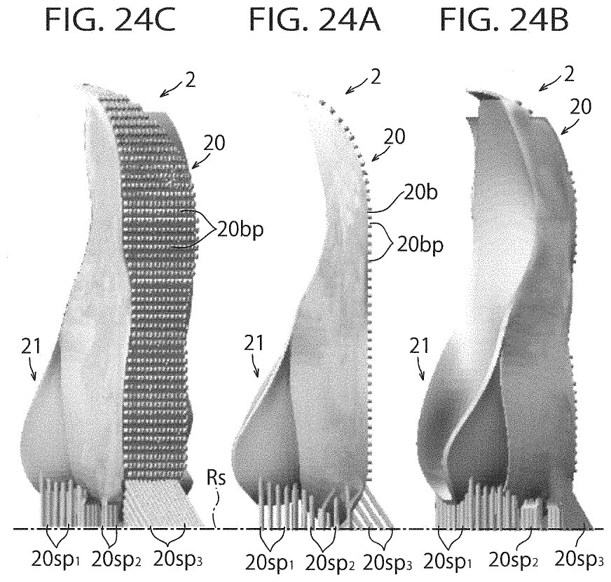

In the above-mentioned embodiment, an example was shown in which at the time of forming/shaping the sole by the 3D printer forming/shaping is performed with the sole bottom surface 20b disposed on the reference plane Rf in the horizontal posture, but the application of the present is not limited to such an example. FIGS. 24A to 24C show a variant of the sole forming process according to the present invention. In these drawings, like reference numbers indicate identical or functionally similar elements to those in the above-mentioned embodiment. In the illustrated embodiment, similar to the sixth alternative embodiment, a sole is taken as an example in which ribs at the outer circumferential surface of the sole body 20 and ribs at the outer circumferential surface of the heel counter portion 21 are omitted.

FIG. 24A to 24C illustrate an example in which the sole 2 is formed in a standing posture that the heel rear end surface of the sole 2 is disposed on the reference plane Rs, showing the state after forming by the 3D printer. As shown in FIG. 24A, the bottom surface 20b mainly at midfoot region M of the sole body 20 is generally perpendicular to the reference plane Rs. At the tiptoe portion of the sole body 20, the toe spring portion is formed and at the heel rear end of the sole body 20, the heel-up portion is formed. At the rear end surface of the heel counter portion 21, a plurality of pillar-shaped supports 20sp₁ are formed that extend vertically (i.e. generally perpendicularly to the reference plane Rs). At the heel rear end of the sole body 20, a plurality of pillar-shaped supports 20sp₂ are formed that extend in a direction generally perpendicular to the reference plane Rs from the heel rear end. At the heel-up portion at the heel rear end of the sole body 20, a plurality of pillar-shaped supports 20sp₃ are formed that extend in a direction diagonally intersecting at an acute angle relative to the reference plane Rs.

The pillar-shaped supports 20sp₁ at the heel counter portion 21 and the pillar-shaped supports 20sp₂ at the heel rear end of the sole body 20 are provided to mainly support the sole 2 on the reference plane Rs at the time of forming by the 3D printer, and usually, they are removed by cutting and the like after forming by the 3D printer except for such a special occasion as to aim for a design effect. On the other hand, the pillar-shaped supports 20sp₃ at the heel-up portion of the sole body 20 maybe removed after forming by the 3D printer, but as with the above-mentioned embodiment, it is preferable to cut the pillar-shaped supports 20sp₃ with the proximal portions thereof left behind. Additionally, in this case, the toe spring portion of the sole body 20 can be formed by the 3D printer without requiring pillar-shaped supports.

In this seventh alternative embodiment as well, similar to the above-mentioned embodiment, at the time of forming the sole by the 3D printer, since a support member formed at the heel-up portion of the bottom surface 20b of the sole body 20 is composed of a plurality of pillar-shaped supports 20sp₃, it becomes easy to cut the pillar-shaped supports 20sp₃ after forming not only at the heel-up portion of the sole body 20 but also on the side of sole bottom surface 20b, thus facilitating manufacture of the sole with an inclined/curved surface.

Also, the proximal portion of the pillar-shaped supports 20sp₃ can be utilized as a ground-contact surface design of the heel-up portion of the sole body 20, thus further facilitating manufacture of the sole. Moreover, since a number of protrusions having substantially the same shape are formed at the whole sole bottom surface 20b including the heel-up portion of the sole body 20, not only design at the whole sole bottom surface 20b can be unified and design effect can be exhibited but also gripping performance, skid-proof capacity and drainability as a ground contact surface can be improved over the whole sole bottom surface 20b by these protrusions.

### Eighth Alternative Embodiment

In the seventh alternative embodiment, an example was shown in which the sole 2 is formed in an upright standing posture on the reference plane Rs, but the application of the present is not restricted to such an example. The sole 2 may be formed in an oblique standing posture on the reference plane Rs, that is, in such a posture that the bottom surface 20b (FIG. 24A) mainly at the midfoot region of the sole 2 forms an acute or obtuse angle to the reference plane Rs.

### Ninth Alternative Embodiment

In the above-mentioned embodiment, an example was shown in which the bottom surface 20b of the sole body 20 is formed of a planar surface or gently curved surface in the longitudinal and lateral directions and the pillar-shaped protrusions 20bp are provided at the generally entire bottom surface 20b (see FIG. 4), but the application of the present is not restricted to such an example.

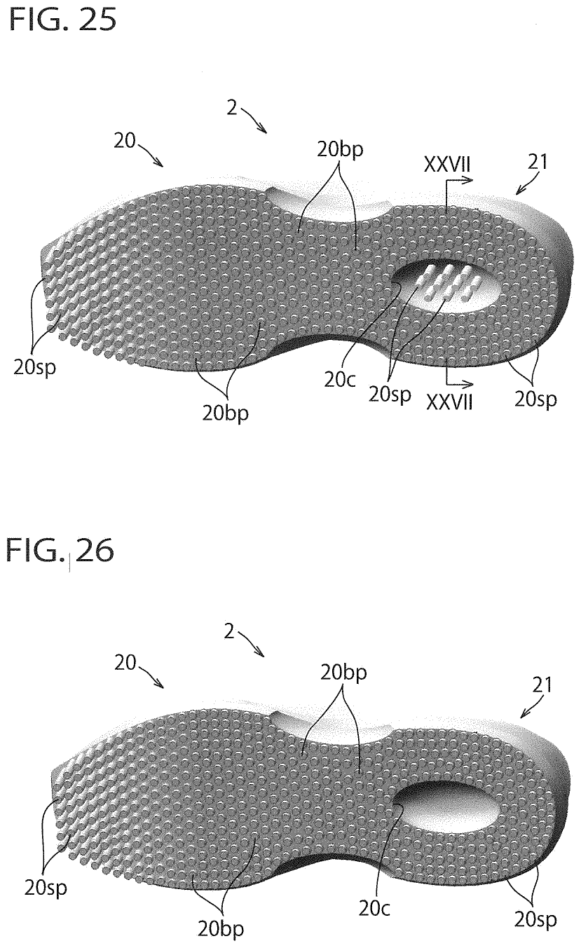

As shown in FIGS. 25 and 26, there may be formed a concave portion 20c in the bottom surface 20b at for example, the heel region of the sole body 20. FIG. 25 shows the state in which the pillar-shaped supports 20sp are formed at the concave portion 20c and FIG. 26 shows the state in which the pillar-shaped supports 20sp of FIG. 25 are removed from the concave portion 20c.

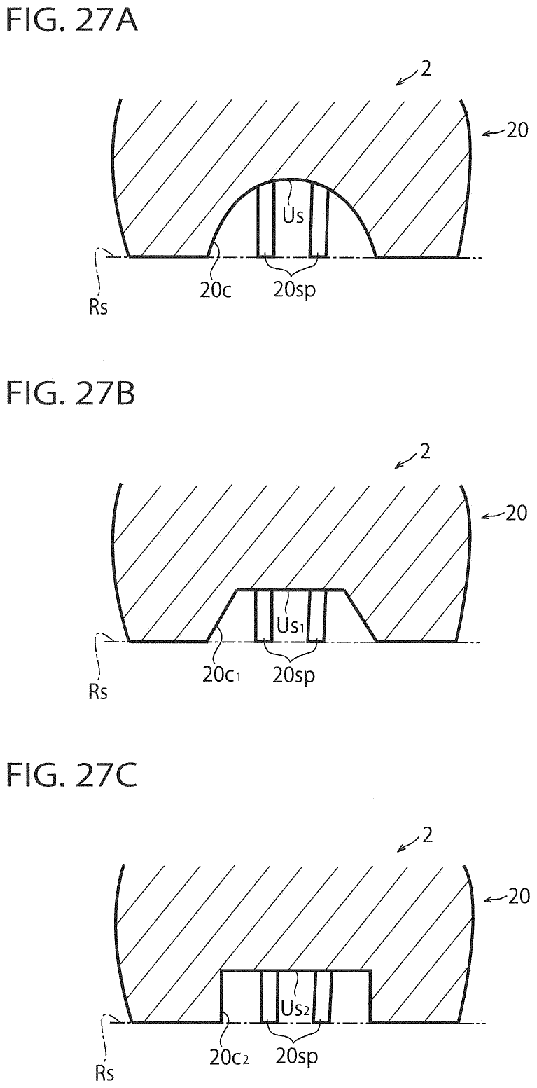

As shown in FIG. 27A, a cross sectional view of FIG. 25 taken along line XXVII-XXVII, since a ceiling surface or a top wall surface (i.e. a supported surface) Us forming the concave portion 20c has an arch-shaped, or circular/semicircular-shaped cross-sectional shape, such a surface needs support by means of a plurality of pillar-shaped supports 20sp at the time of forming by the 3D printer. The pillar-shaped supports 20sp are laterally spaced apart at a predetermined interval in the concave portion 20c. Since the ceiling surface/top wall surface Us also has an arch-shaped (or gently curved, alternatively, linear) longitudinal section, the pillar-shaped supports 20sp are also longitudinally spaced apart at a predetermined interval in the concave portion 20c (see FIG. 25). The pillar-shaped supports 20sp extend downwardly to the reference plane Rs, i.e. the sole bottom surface.

The cross-sectional shape of the concave portion 20c is not restricted to the arch-shape as shown in FIG. 27A, but a trapezoidal shape shown in FIG. 27B, or a rectangular shape shown in FIG. 27C may be adopted.

In a concave portion 20c₁ shown in FIG. 27B, since a ceiling surface or a top wall surface (i.e. a supported surface) Us₁ forming the concave portion 20c₁ extends parallel to the reference plane Rs, i.e. in a horizontal direction, such a surface needs support by means of a plurality of pillar-shaped supports 20sp at the time of forming by the 3D printer. The pillar-shaped supports 20sp are laterally spaced apart at a predetermined interval in the concave portion 20c₁. Since the ceiling surface/top wall surface Us₁ also has a gently curved or linear longitudinal-sectional shape, the pillar-shaped supports 20sp are also longitudinally spaced apart at a predetermined interval in the concave portion 20c₁. The pillar-shaped supports 20sp extend downwardly to the reference plane Rs, i.e. the sole bottom surface.

In a concave portion 20c₂ shown in FIG. 27C, similar to the concave portion 20c₁, since a ceiling surface or a top wall surface (i.e. a supported surface) Us₂ forming the concave portion 20c₂ extends parallel to the reference plane Rs, i.e. in the horizontal direction, such a surface needs support by means of a plurality of pillar-shaped supports 20sp at the time of forming by the 3D printer. The pillar-shaped supports 20sp are laterally spaced apart at a predetermined interval in the concave portion 20c₂. Since the ceiling surface/top wall surface Use also has a gently curved or linear longitudinal-sectional shape, the pillar-shaped supports 20sp are also longitudinally spaced apart at a predetermined interval in the concave portion 20c₂. The pillar-shaped supports 20sp extend downwardly to the reference plane Rs, i.e. the sole bottom surface.

In either case, at the time of forming by the 3D printer, since the ceiling surface or top wall surface (i.e. supported surface) Us, Us₁, Us₂ of the concave portions 20c, 20c₁, 20c₂ are supported by the plurality of pillar-shaped supports 20sp, cutting of the pillar-shaped supports 20sp after forming becomes easy. Thereby, manufacture of a sole having a concave portion at a sole bottom surface can be facilitated.

### Tenth Alternative Embodiment

In the above-mentioned embodiment, an example was shown in which the side-up portions Su are provided in need of support by a support member or a support at the lower edge portions of the medial and lateral sides (see FIGS. 14 and 16), but the application of the present is not restricted to such an example.

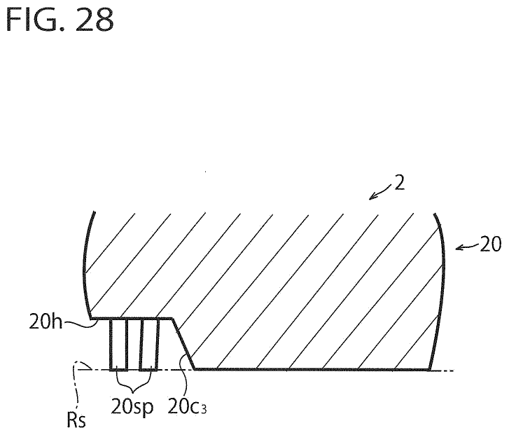

As shown in FIG. 28, there may be formed a cutout or notch portion 20c₃ at a lower edge portion of the medial or lateral side of the sole body 20. Since a ceiling surface or a top wall surface (i.e. a supported surface) 20h forming the notch portion 20c₃ extends parallel to the reference plane Rs, i.e. in the horizontal direction and is an overhang, such a surface needs support by means of a plurality of pillar-shaped supports 20sp at the time of forming by the 3D printer. The pillar-shaped supports 20sp are laterally spaced apart at a predetermined interval in the notch portion 20c₃. Since the ceiling surface/top wall surface 20h also has a linear longitudinal-sectional shape, the pillar-shaped supports 20sp are also longitudinally spaced apart at a predetermined interval in the notch portion 20h. The pillar-shaped supports 20sp extend downwardly to the reference plane Rs at the time of forming.

In this case as well, at the time of forming by the 3D printer, since the ceiling surface or top wall surface (i.e. supported surface) 20h of the notch portion 20c₃ is supported by a plurality of pillar-shaped supports 20sp, cutting of the pillar-shaped supports 20sp after forming becomes easy. Thereby, manufacture of a sole having a notch portion at a sole lower edge portion can be facilitated.

### <Other Application>

In the above-mentioned embodiment and the first to tenth alternative embodiments, an example was shown in which the present invention was applied to the sole of the running shoe, but the application of the present invention is not restricted to such an example. The present invention also has application to walking shoes, soccer shoes, other sports shoes or shoes including sandals. That is, the present invention is applicable to an article of footwear in general.

As mentioned above, the present invention is useful for a sole manufacturing method in which manufacture of a sole with a supported surface by a support can be facilitated using a 3D printer.

Those skilled in the art to which the invention pertains may make modifications and other embodiments employing the principles of this invention without departing from its spirit or essential characteristics particularly upon considering the foregoing teachings. The described embodiments and examples are to be considered in all respects only as illustrative and not restrictive. The scope of the invention is, therefore, indicated by the appended claims rather than by the foregoing description. Consequently, while the invention has been described with reference to particular embodiments and examples, modifications of structure, sequence, materials and the like would be apparent to those skilled in the art, yet fall within the scope of the invention.

What is claimed is:

1. A method for manufacturing a sole of an article of footwear, wherein said method is an additive manufacturing using a 3D printer and said sole includes a supported surface that is supported by a support at the time of forming said sole by said 3D printer, said method comprising:
a forming process in which a plurality of pillar-shaped supports that extend from said supported surface toward a bottom surface of said sole are formed at the time of forming said sole by said 3D printer; and
a cutting process to cut at least a part of said pillar-shaped supports.

2. The method according to claim 1, wherein said supported surface is an inclined surface or a curved surface that is provided at a toe spring portion of a tiptoe part of said sole, a heel-up portion at a heel rear end of said sole, or a side-up portion at a lower end edge portion on medial and lateral sides of said sole.

3. The method according to claim 1, wherein said supported surface is a concaved ceiling surface formed at said bottom surface of said sole.

4. The method according to claim 1, wherein said pillar-shaped supports are arranged in alignment at predetermined intervals at said supported surface.

5. The method according to claim 1, wherein in said cutting process, said pillar-shaped supports formed at said supported surface are cut with a proximal portion of said pillar-shaped supports remained so that said pillar-shaped supports can constitute a ground-contact surface design at said bottom surface of said sole.

6. The method according to claim 5, wherein at a remaining part of said lower surface of said sole, there are formed a plurality of convex portions similar to said proximal portions of said pillar-shaped supports and said convex portions constitute a ground-contact surface design at said bottom surface of said sole along with said proximal portions of said pillar-shaped supports.

7. The method according to claim 1, wherein in said cutting process, said pillar-shaped supports are removed from said supported surface of said sole.

8. The method according to claim 1, wherein in said forming process of said sole by said 3D printer, a plurality of protrusions are formed that extend in a direction intersecting a circumferential direction on an outer circumferential surface of said sole and bottom portions of said protrusions constitute a ground-contact surface design at said bottom surface of said sole along with said pillar-shaped supports.

9. The method according to claim 1, wherein said additive manufacturing is a fused deposition modeling.

10. The method according to claim 1, wherein forming of said sole and said pillar-shaped supports through said additive manufacturing by said 3D printer is performed using a soft material having an Asker A hardness of 90 A or less.
